(19) United States
(12) Patent Application Publication
(10) Pub. No.: US 2022/0212688 A1
(43) Pub. Date: Jul. 7, 2022

(54) CONTENT PLAYER AND METHOD FOR CONTENT PLAYBACK

(71) Applicant: TOYOTA JIDOSHA KABUSHIKI KAISHA, Toyota-shi (JP)

(72) Inventors: Shinichi SHIRAISHI, Saitama-shi (JP); Koshiro HASHIMOTO, Tokyo-to (JP); Kengo KIDO, Ichikawa-shi (JP)

(21) Appl. No.: 17/565,515

(22) Filed: Dec. 30, 2021

(30) Foreign Application Priority Data
Jan. 7, 2021 (JP) 2021-001312

(51) Int. Cl. B60W 50/14; B60W 40/02; B60W 40/09; B60W 50/08; G01C 21/34

(52) U.S. Cl. CPC B60W 50/14; B60W 40/02; B60W 2050/007; B60W 50/085; G01C 21/3415; B60W 40/09

(57) ABSTRACT

A content player calculates control duration during which control at a current control level continues, the current control level being one of a plurality of control levels of a travel control unit that controls travel of a vehicle; selects a piece of content such that time required for playback is shorter than the control duration, from among a plurality of pieces of content; and plays back the selected piece of content by an output device mounted on the vehicle when travel of the vehicle is controlled at the current control level.

### FIELD

The present disclosure relates to a device and a method for playing back content by output device mounted on a vehicle.

### BACKGROUND

Vehicles mounted with a player to play back content are known. Occupants of a vehicle can view or listen to content played back by the player during travel of the vehicle.

Japanese Unexamined Patent Publication No. 2018-177064 describes a content player that switches content being played back from moving pictures to music according to a change from autonomous driving by a travel controller that controls travel of a vehicle to manual driving by a driver's control.

### SUMMARY

A driver need not control travel of a vehicle during autonomous driving under control by a travel controller. However, depending on the circumstances of the vehicle, there is a case in which the travel controller cannot continue autonomous driving and requests a change to manual driving. To keep the driver awake until autonomous driving is finished, it is desirable to appropriately present content to the driver according to the circumstances of autonomous driving.

It is an object of the present disclosure to appropriately present content to a driver according to the circumstances of autonomous driving.

A first content player according to the present disclosure includes a processor configured to calculate control duration during which control at a current control level continues, the current control level being one of a plurality of control levels of a travel control unit that controls travel of a vehicle; select a piece of content such that time required for playback is shorter than the control duration, from among a plurality of pieces of content; and play back the selected piece of content by an output device mounted on the vehicle when travel of the vehicle is controlled at the current control level.

The processor of the first content player according to the present disclosure preferably selects content of a type that a driver of the vehicle is allowed to view or listen to at the current control level from among the plurality of pieces of content.

The processor of the first content player according to the present disclosure preferably selects a piece of content that does not include an image when the current control level is such that the driver of the vehicle has a monitoring obligation, and selects a piece of content including images when the current control level is such that the driver does not have a monitoring obligation.

A second content player according to the present disclosure includes a processor configured to calculate control duration during which control at a current control level continues on a travel route from a current location to a destination, the current control level being one of a plurality of control levels of a travel control unit that controls travel of a vehicle; play back a piece of content by an output device mounted on the vehicle; and suggest to a driver of the vehicle an alternative travel route on which control at the current control level is continuable longer than time required for playback of the piece of content when the time required for playback is longer than the control duration.

A first method for content playback according to the present disclosure includes calculating control duration during which control at a current control level continues, the current control level being one of a plurality of control levels of a travel control unit that controls travel of a vehicle; selecting a piece of content such that time required for playback is shorter than the control duration, from among a plurality of pieces of content; and playing back the selected piece of content by an output device mounted on the vehicle when travel of the vehicle is controlled at the current control level.

A second method for content playback according to the present disclosure includes calculating control duration during which control at a current control level continues on a travel route from a current location to a destination, the current control level being one of a plurality of control levels of a travel control unit that controls travel of a vehicle; playing back a piece of content by an output device mounted on the vehicle; and suggesting to a driver of the vehicle an alternative travel route on which control at the current control level is continuable longer than time required for playback of the piece of content when the time required for playback is longer than the control duration.

The content player according to the present disclosure can appropriately present content to a driver according to the circumstances of autonomous driving.

### BRIEF DESCRIPTION OF DRAWINGS

FIG. 1 schematically illustrates the configuration of a vehicle including a content player.

FIG. 2 illustrates the hardware configuration of a travel controller.

FIG. 3 illustrates the hardware configuration of the content player.

FIG. 4 is a functional block diagram of a processor included in the content player.

FIG. 5 is an operation flowchart of a first content playback process.

FIG. 6 is an operation flowchart of a second content playback process.

### DESCRIPTION OF EMBODIMENTS

Hereinafter, a content player will be explained in detail with reference to the drawings. The content player calculates control duration during which control at a current control level continues. The current control level is one of a plurality of control levels of a travel control unit that controls travel of a vehicle. Additionally, the content player selects a piece of content such that time required for playback is shorter than the control duration, from among a plurality of pieces of content, and plays back the selected piece of content by an output device mounted on the vehicle when travel of the vehicle is controlled at the current control level.

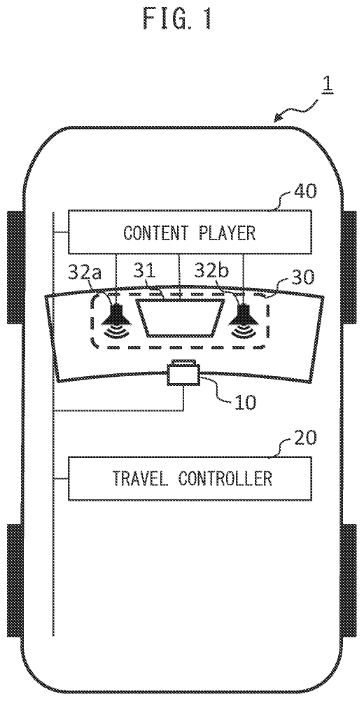

FIG. 1 schematically illustrates the configuration of a vehicle 1 including a content player. The vehicle 1 includes a camera 10, a travel controller 20, an output device 30, and a content player 40. The camera 10 and the travel controller 20 are connected via an in-vehicle network conforming to a standard, such as a controller area network, so that they can communicate with each other; so are the travel controller 20 and the content player 40.

The camera 10 is an example of a sensor that generates a signal representing surroundings of the vehicle, and includes a two-dimensional detector constructed from an array of optoelectronic transducers, such as CCD or C-MOS, having sensitivity to visible light and a focusing optical system that forms an image of a target region on the two-dimensional detector. The camera 10 is mounted in the interior of the vehicle 1 so as to be oriented, for example, to the front of the vehicle 1. The camera 10 captures a region in front of the vehicle 1 every predetermined capturing period (e.g., 1/30 to 1/40 seconds), and generates images of this region. The images obtained by the camera 10 may be color or monochrome images. The vehicle 1 may include multiple cameras taking pictures in different orientations or having different focal lengths.

Every time it generates an image, the camera 10 outputs the generated image to the travel controller 20 via the in-vehicle network.

As a sensor other than the camera 10, the vehicle 1 may include a light detection and ranging (LiDAR) sensor (not shown) that generates a range image of surroundings of the vehicle, and a global navigation satellite system (GNSS) receiver (not shown) that determines the location of the vehicle 1, based on GNSS signals received from GNSS satellites.

The travel controller 20, which is an example of the travel control unit, is an electronic control unit (ECU) including a communication interface, a memory, and a processor. The travel controller 20 controls travel of the vehicle 1, using images received from the camera 10 via the communication interface.

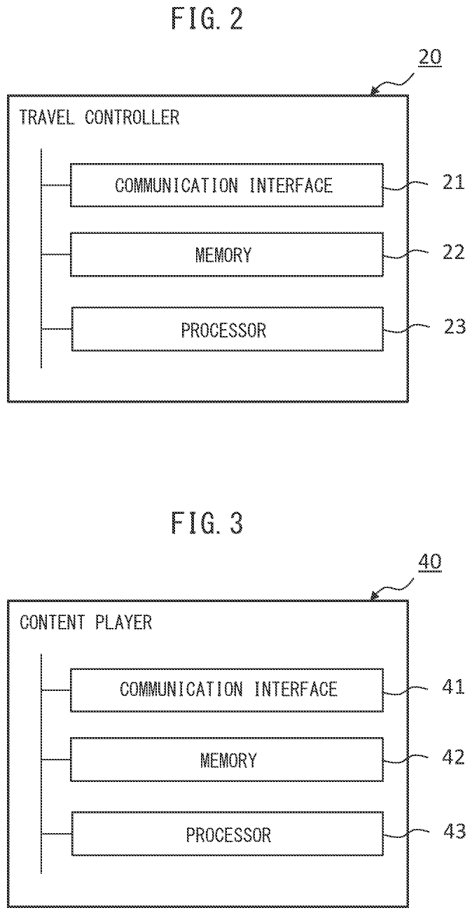

FIG. 2 illustrates the hardware configuration of the travel controller 20. The travel controller 20 includes a communication interface 21, a memory 22, and a processor 23.

The communication interface 21 is an example of a communication unit, and includes a communication interface circuit for connecting the travel controller 20 to the in-vehicle network. The communication interface 21 provides received data to the processor 23, and outputs data provided from the processor 23 to an external device.

The memory 22 is an example of a storage unit, and includes volatile and nonvolatile semiconductor memories. The memory 22 stores various types of data used for processing by the processor 23, such as parameters used by a classifier that detects an object from an image. The memory 22 also stores various application programs, such as a program to execute components of an autonomous driving process.

The processor 23 is an example of a control unit, and includes one or more processors and a peripheral circuit thereof. The processor 23 may further include another operating circuit, such as a logic-arithmetic unit, an arithmetic unit, or a graphics processing unit.

The travel controller 20 detects objects around the vehicle 1 from an image generated by the camera 10 and representing surroundings of the vehicle 1.

The travel controller 20 inputs a received image representing surroundings of the vehicle 1 into a classifier that has been trained to detect an object from an image, thereby detecting objects around the vehicle.

The classifier may be, for example, a convolution neural network (CNN) including multiple convolutional layers connected in series from the input toward the output. A CNN that has been trained using inputted images, for example, including vehicles and lane lines as training data operates as a classifier that detects vehicles and lane lines.

The travel controller 20 outputs a control signal to a travel mechanism (not shown) of the vehicle 1 via the communication interface 21 to control motion of the vehicle 1 so that it will not collide with the detected objects. The travel mechanism includes, for example, an engine or a motor for supplying motive power to the vehicle 1, a brake for decreasing the travel speed of the vehicle 1, and a steering mechanism for steering the vehicle 1.

The travel controller 20 controls travel of the vehicle 1 at one of a plurality of control levels. For example, when the vehicle 1 cannot travel at a predetermined speed or faster due to a traffic jam, the travel controller 20 controls travel of the vehicle 1 at a control level in which the driver does not have a monitoring obligation (level 3 of autonomous driving or higher). When there is no traffic jam and the vehicle 1 can travel at a speed not greater than a regulation speed nor less than the predetermined speed, the travel controller 20 controls travel of the vehicle 1 at a control level in which the driver has a monitoring obligation (level 2 of autonomous driving or lower).

The output device 30 outputs, to the driver, signals representing content received from the content player 40 so that he/she can view or listen to it. The output device 30 includes a display 31 that displays images and speakers 32a and 32b (collectively referred to as speakers 32) that output voices.

The content player 40 is an ECU including a communication interface, a memory, and a processor. The content player 40 makes the output device 30 play back a piece of content selected depending on the control level at which the travel controller 20 controls travel of the vehicle 1. The content player 40 may be configured as a car navigation system that has the content playback function.

FIG. 3 illustrates the hardware configuration of the content player 40. The content player 40 includes a communication interface 41, a memory 42, and a processor 43.

The communication interface 41 is an example of a communication unit, and includes a communication interface circuit for connecting the content player 40 to the in-vehicle network. The communication interface 41 provides received data to the processor 43, and outputs data provided from the processor 43 to an external device.

The memory 42 is an example of a storage unit, and includes volatile and nonvolatile semiconductor memories. The memory 42 stores various types of data used for processing by the processor 43, such as information on types of content associated with the respective control levels and map information for navigation. The memory 42 also stores various application programs, such as a program to execute a content playback process.

The processor 43 is an example of a control unit, and includes one or more processors and a peripheral circuit thereof. The processor 43 may further include another operating circuit, such as a logic-arithmetic unit, an arithmetic unit, or a graphics processing unit.

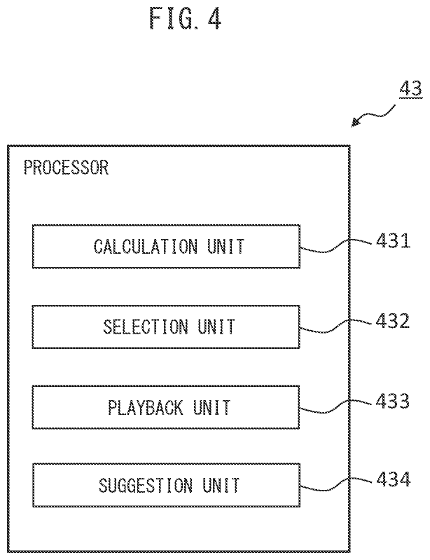

FIG. 4 is a functional block diagram of the processor 43 included in the content player 40.

As components of its functional blocks, the processor 43 of the content player 40 includes a calculation unit 431, a selection unit 432, a playback unit 433, and a suggestion unit 434. These units included in the processor 43 are functional modules implemented by a program executed on the processor 43, or may be implemented in the content player 40 as separate integrated circuits, microprocessors, or firmware.

The calculation unit 431 calculates control duration during which control at the current control level of the travel controller 20 continues.

The calculation unit 431 obtains information indicating the current control level from the travel controller 20 via the in-vehicle network. The calculation unit 431 refers to the map information stored in the memory 42 to determine a travel route of the vehicle 1 from the current location of the vehicle 1 to a destination in accordance with a predetermined route searching technique, such as Dijkstra's algorithm. Additionally, the calculation unit 431 obtains traffic information representing traffic situations, such as traffic jams and traffic restrictions on the travel route, via a data communication module (not shown) connected to the in-vehicle network, a wireless base station (not shown), and a communication network (not shown).

The calculation unit 431 predicts the location where control at the current control level will be finished, based on the obtained traffic information. Then, the calculation unit 431 divides the distance from the current location to the location where the control will be finished by a normal speed in control at the control level, thereby calculating the control duration.

The selection unit 432 selects a piece of content such that time required for playback is shorter than the control duration, from among a plurality of pieces of content stored in the memory 42. For example, when the control duration is 30 minutes and playback of pieces A and B of content requires an hour and 30 minutes, respectively, the selection unit 432 selects piece B from among pieces A and B.

The selection unit 432 refers to the time required for playback of individual pieces of content stored in the memory 42 and library information indicating types of content, such as moving pictures and music, to select a piece of content.

The selection unit 432 selects content of a type that the driver of the vehicle 1 is allowed to view or listen to at the current control level from among the plurality of pieces of content.

For example, when the current control level is such that the driver has a monitoring obligation, e.g., level 2 of autonomous driving, the selection unit 432 selects a piece of content that does not include an image, such as music. When the current control level is such that the driver does not have a monitoring obligation, e.g., level 3 of autonomous driving, the selection unit 432 selects a piece of content including images, such as moving pictures.

Alternatively, the selection unit 432 may select a piece of content from among a plurality of pieces of content stored in a content server (not shown) connected via the data communication module (not shown) connected to the in-vehicle network, the wireless base station (not shown), and the communication network (not shown). In this case, the library information is stored in the memory 42 or the content server.

The playback unit 433 plays back content by the output device 30. The playback unit 433 makes the output device 30 play back content when travel of the vehicle 1 is controlled at the current control level. For example, a piece of content whose type is moving pictures is played back using the display 31 and the speakers 32 of the output device 30. A piece of content whose type is music is played back using the speakers 32 of the output device 30.

The suggestion unit 434 suggests to the driver an alternative travel route on which control at the current control level is continuable longer than the time required for playback of the piece of content played back by the playback unit 433 when the time required for playback is longer than the control duration.

The suggestion unit 434 refers to the map information stored in the memory 42 to identify, as the alternative travel route, a travel route on which control at the current control level is continuable longer than the time required for playback, among those travel routes of the vehicle 1 from the current location of the vehicle 1 to a destination which are searched for in accordance with a predetermined route searching technique, such as Dijkstra's algorithm.

Then, the suggestion unit 434 suggests the alternative travel route to the driver via the output device 30. For example, the suggestion unit 434 makes the display 31 show an image representing the alternative travel route, and receives the driver's operational input for instructing that the travel route be changed. The driver's operational input is, for example, a touch operation on a predetermined region in a touch sensor superposed on the display 31. The suggestion unit 434 may make the output device 30 stop playing back content while suggesting the alternative travel route to the driver.

The content player 40 need not have the function of generating a travel route. If it does not have the function, the calculation unit 431 and the suggestion unit 434 obtain a travel route from a car navigation device (not shown) connected to the in-vehicle network.

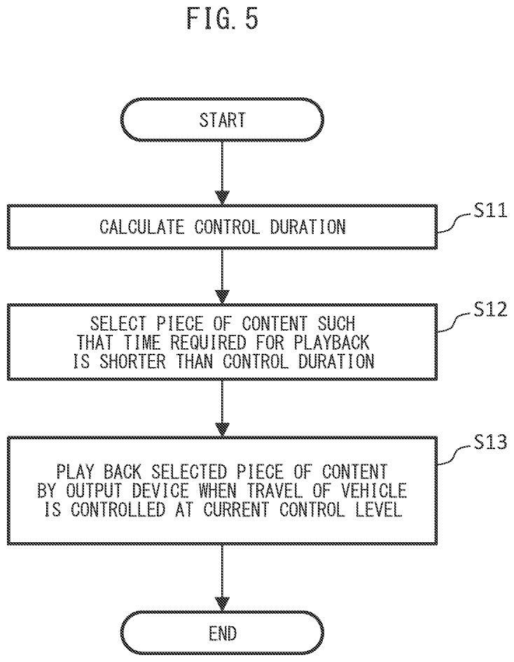

FIG. 5 is an operation flowchart of a first content playback process.

Every time the control level of the travel controller 20 is changed, the content player 40 executes the first content playback process in accordance with the following operation flowchart. The content player 40 may execute the first content playback process at predetermined time intervals (e.g. every five minutes) during the control by the travel controller 20.

The calculation unit 431 of the content player 40 calculates control duration during which control at the current control level of the travel controller 20 continues (step S11).

Next, the selection unit 432 of the content player 40 selects a piece of content such that time required for playback is shorter than the control duration, from among a plurality of pieces of content (step S12).

The playback unit 433 of the content player 40 plays back the selected piece of content by the output device 30 when the vehicle 1 is controlled at the current level by the travel controller 20 (step S13). Then, it terminates the first content playback process.

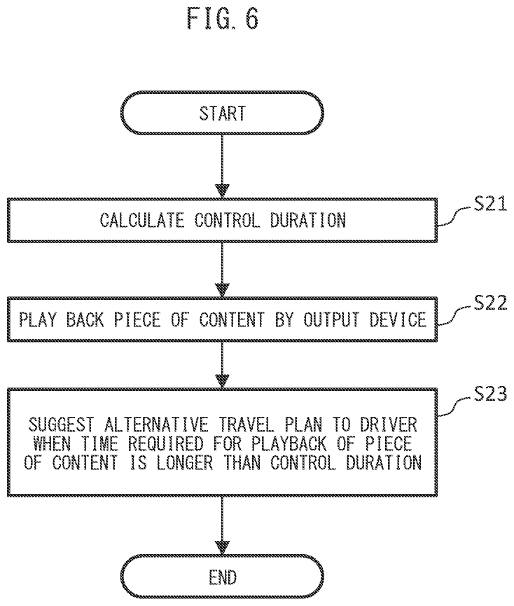

FIG. 6 is an operation flowchart of a second content playback process.

The content player 40 executes the second content playback process at predetermined time intervals (e.g. every five minutes) during the control by the travel controller 20.

The calculation unit 431 of the content player 40 calculates control duration during which control at the current control level of the travel controller 20 continues (step S21).

Next, the playback unit 433 of the content player 40 plays back a piece of content by the output device 30 (step S22).

The suggestion unit 434 of the content player 40 suggests to the driver of the vehicle 1 an alternative travel route on which control at the current level is continuable longer than time required for playback of the piece of content when the time required for playback is longer than the control duration (step S23). Then, it terminates the second content playback process.

By executing the first content playback process, the content player 40 can select a piece of content shorter than control duration during which control at the current control level continues, and make the output device play it back. Thus the content player 40 that executes the first content playback process can appropriately present content to the driver so that playback of the content will not be stopped in the middle thereof by a change of the control level.

By executing the second content playback process, the content player 40 can suggest to the driver an alternative travel route on which control at the current control level continues longer than the time required for playback of a piece of content being played back. Thus the content player 40 that executes the second content playback process can appropriately present content to the driver so that playback of the content will not be stopped in the middle thereof by a change of the control level.

Note that those skilled in the art can apply various changes, substitutions, and modifications without departing from the spirit and scope of the present disclosure.

What is claimed is:

1. A content player comprising a processor configured to
calculate control duration during which control at a current control level continues, the current control level being one of a plurality of control levels of a travel controller that controls travel of a vehicle;
select a piece of content such that time required for playback is shorter than the control duration, from among a plurality of pieces of content; and
play back the selected piece of content by an output device mounted on the vehicle when travel of the vehicle is controlled at the current control level.

2. The content player according to claim 1, wherein in selecting, the processor is configured to select content of a type that a driver of the vehicle is allowed to view or listen to at the current control level from among the plurality of pieces of content.

3. The content player according to claim 2, wherein in selecting, the processor is configured to select a piece of content that does not include an image when the current control level is such that the driver of the vehicle has a monitoring obligation, and select a piece of content including images when the current control level is such that the driver does not have a monitoring obligation.

4. A content player comprising a processor configured to
calculate control duration during which control at a current control level continues on a travel route from a current location to a destination, the current control level being one of a plurality of control levels of a travel controller that controls travel of a vehicle;
play back a piece of content by an output device mounted on the vehicle; and
suggest to a driver of the vehicle an alternative travel route on which control at the current control level is continuable longer than time required for playback of the piece of content when the time required for playback is longer than the control duration.

5. A method for content playback, comprising:
calculating control duration during which control at a current control level continues, the current control level being one of a plurality of control levels of a travel control unit that controls travel of a vehicle;
selecting a piece of content such that time required for playback is shorter than the control duration, from among a plurality of pieces of content; and
playing back the selected piece of content by an output device mounted on the vehicle when travel of the vehicle is controlled at the current control level.

6. A method for content playback, comprising:
calculating control duration during which control at a current control level continues on a travel route from a current location to a destination, the current control level being one of a plurality of control levels of a travel control unit that controls travel of a vehicle;
playing back a piece of content by an output device mounted on the vehicle; and
suggesting to a driver of the vehicle an alternative travel route on which control at the current control level is continuable longer than time required for playback of the piece of content when the time required for playback is longer than the control duration.
